(19) United States
(12) Patent Application Publication
(10) Pub. No.: US 2005/0289214 A1
(43) Pub. Date: Dec. 29, 2005

(54) Mobility enabled system architecture software architecture and application programing interface

(75) Inventors: Pascal Adjakple, Great Neck, NY (US); Bhavin Dalal, Dallas, TX (US); Nihar Anikumar Doshi, Deer Park, NY (US); Lakshmi Erukulapati, Wheatley Heights, NY (US); Sven Forner, Dresden (DE); Prasanth Krishnam, Lawrenceville, GA (US); Eric Mascio, Bethpage, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/072,153

(22) Filed: Mar. 4, 2005

Related U.S. Application Data
(60) Provisional application No. 60/550,072, filed on Mar. 4, 2004.

(51) Int. Cl. G06F 15/16

(52) U.S. Cl. 709/200

(57) ABSTRACT

The present invention is related to the software architecture and supporting application programming interface (API) that enable operating system (OS) independence and platform independence of a mobility enabled system architecture (MESA) in a wireless local area network (WLAN). The present invention provides a system for supporting portable and modular software implementation in different platforms in a WLAN node. The node includes a control plane configured to implement a control plane algorithm while interacting with a medium access control (MAC) driver, a data plane configured to implement a data plane algorithm while interacting with the MAC driver and, an operation, administration and maintenance (OAM) handler task configured to interact with the OAM agent. APIs are provided to enable interaction with external modules regardless of the differences of OS, specificity of OAM agent implementation and AP platform differences.

### CROSS REFERENCE TO RELATED APPLICATION

This application claims the benefit of U.S. Provisional Application No. 60/550,072 filed Mar. 4, 2004, which is incorporated by reference as if fully set forth.

### FIELD OF INVENTION

The present invention is related to a wireless communication system. More particularly, the present invention is related to a software architecture and supporting application programming interface (API) that enable operating system (OS) independence and platform independence of a mobility enabled system architecture (MESA) in a wireless local area network (WLAN).

### BACKGROUND

By way of example, a WLAN is typically based on an architecture where the system is subdivided into cells wherein each cell may be referred to as a basic service set (BSS). Each cell is typically controlled by an access point (AP). Communication between the AP and the stations (STAs) is defined, for example, by the 802.11 standard. Even though a WLAN may be formed by a single cell, with a single AP, most WLANs comprise several cells wherein APs are connected through a backbone, called a distribution system (DS), typically Ethernet. The whole interconnected WLAN including the different cells, their respective APs, and the DS is typically considered a single 802.11 network and may be referred to as an extended service set (ESS).

### SUMMARY

The present invention is related to the software architecture and supporting API that enable OS independence and platform independence of a MESA in a WLAN. The present invention provides a system for supporting portable and modular software implementation in different platforms in a WLAN node. The node includes a control plane configured to implement a control plane algorithm and interact with a medium access control (MAC) driver, a data plane configured to implement a data plane algorithm and interact with the MAC driver and an operation, administration and maintenance (OAM) handler task configured to interact with the OAM agent. APIs are provided to enable interaction with external modules regardless of the differences of OS, specificity of OAM agent implementation and AP platform differences. The control plane includes a channel quality control task and the data plane includes a data-in task and a data-out task. The channel quality control task collects measurements from the MAC driver and coordinates with other tasks. The data-in task and the data-out task transfers data from and to the MAC driver.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a high level functional block diagram of a MESA software architecture in accordance with the present invention;

FIG. 2 is a block diagram of a MESA software task level architecture;

FIG. 3 is a block diagram of a MESA software architecture control plane versus data plane view;

FIG. 4 is an example of integration of MESA software architecture on a commercial AP in accordance with the present invention;

FIG. 5 is a signaling diagram of a startup procedure in accordance with the present invention; and

FIGS. 6 and 7 are block diagrams showing an application programming interface between MESA software and an external environment in accordance with the present invention.

### DETAILED DESCRIPTION OF THE PREFERRED EMBODIMENTS

Hereafter, the terminology “STA” includes but is not limited to a wireless transmit/receive unit, a user equipment, a mobile station, a fixed or mobile subscriber unit, pager, or any other type of device capable of operating in a wireless environment. Additionally, all of these terms may be used interchangeably wherein each of the terms includes, but is not limited to, all of the other terms. When referred to hereafter, the terminology “AP” includes but is not limited to a base station, a Node-B, a site controller or any other type of interfacing device in a wireless environment. Additionally, all of these terms may be used interchangeably wherein each of the terms includes, but is not limited to, all of the other terms.

The focus of MESA is on developing radio resources management (RRM), quality of service (QOS) and mobility management related algorithms in the WLAN nodes such as routers, APs and STAs. The drawings figures used to describe the present invention are mainly AP based. However, it should be noted that the same architecture can also be implemented in other WLAN nodes, such as a WLAN router or WLAN stations, (i.e., mobile terminals). The AP has been used to illustrate MESA software architecture because the fat AP architecture option which concentrates most of the WLAN intelligence in the AP seems to be the predominant AP solution in today's WLAN market.

The AP handles radio frequency communication, authentication of users, encryption of communications, secure roaming, WLAN management, and in some cases network routing. The algorithm intelligence resides in the station management entity (SME). The algorithms interface with the medium access control (MAC) layer management entity (MLME) and physical layer management entity (PLME) through service access point (SAP) interfaces.

Generally, a MESA software architecture in accordance with the present invention allows a software implementation that is modular and easily portable to different customer platforms at a minimum cost and development time. The inclusion of an API layer into the MESA software architecture separates MESA algorithms from the peculiarities of future customers' platforms and OS. This greatly simplifies the integration of MESA software as a middleware into various customers' platforms.

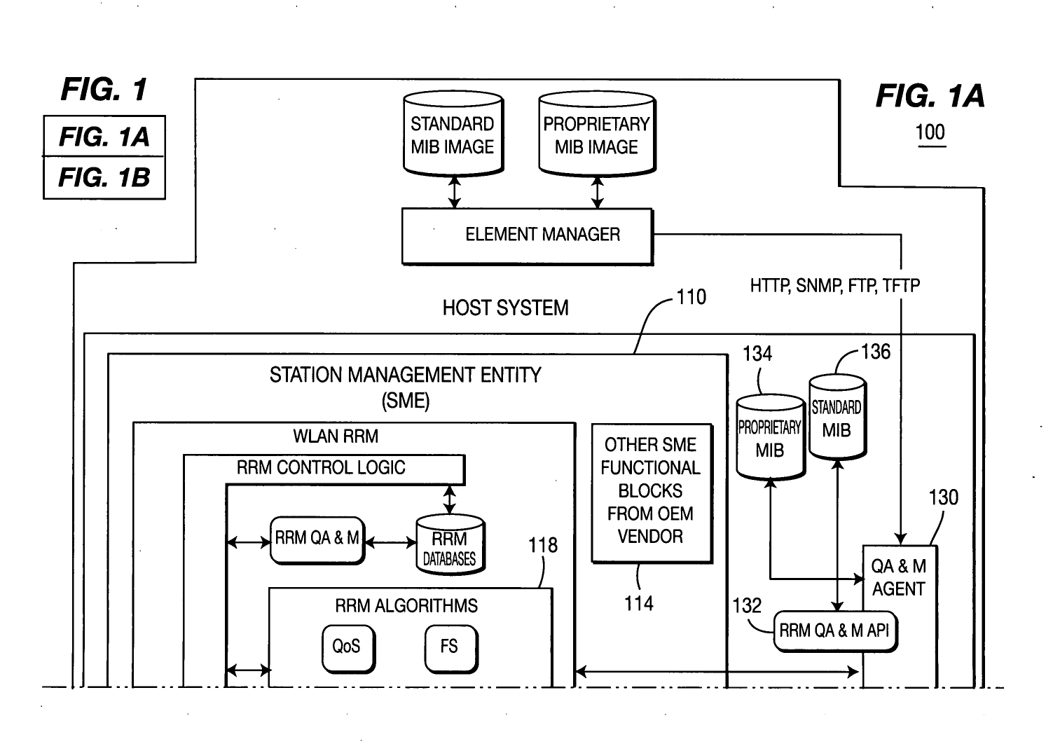

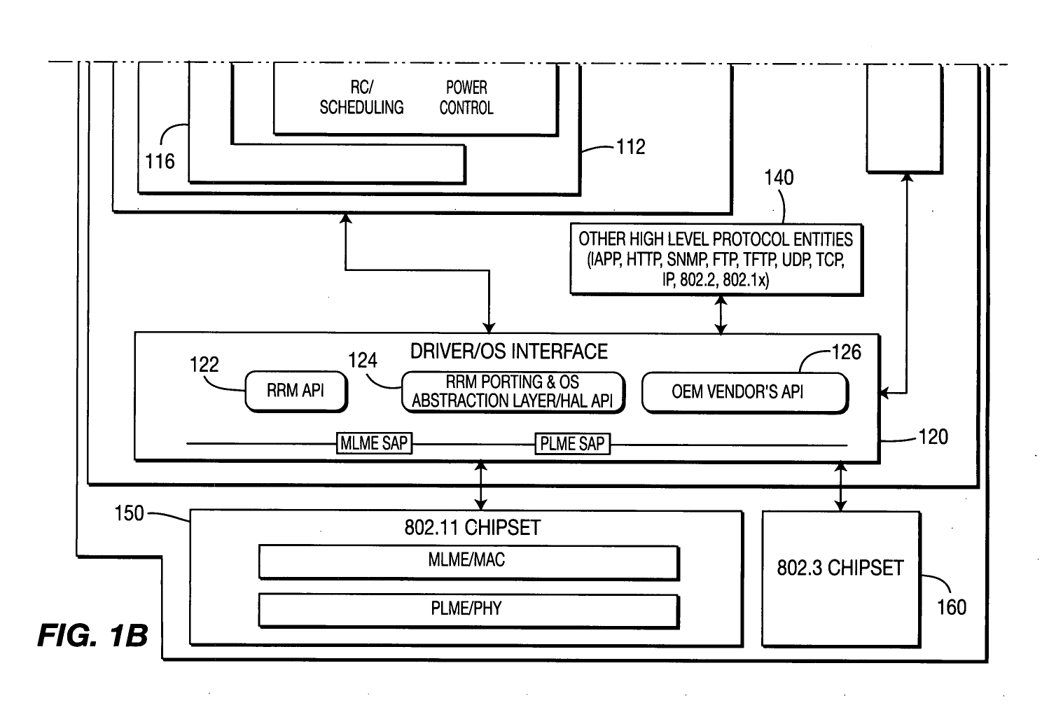

Referring now to the Figures, FIG. 1 is a high level functional block diagram of a system 100 including MESA software architecture in accordance with the present invention. The system 100 includes a station management entity (SME) 110, a medium access control (MAC) driver/OS interface 120, an operation, administration, and maintenance (OAM) agent 130, other higher layer entities such as TCP, IP, http, etc. 140, an 802.11 chipset 150 and an 802.3 chipset 160. The SME 110 includes a WLAN RRM functional block 112 and may also include other SME functional blocks 114 from OEM vendors. The RRM functional block 112 implements RRM control logic 116 and executes RRM algorithms 118 including QoS control, rate control, scheduling and power control, etc.

An RRM API 122 is implemented in the MAC driver 120. The RRM API 122 comprises mainly APIs for collection of measurement and statistics required by RRM algorithms as well as APIs to update the MAC or physical layer with the RRM output. These APIs are mapped to the MAC driver APIs once a specific driver is selected. The RRM API 122 is implemented in the MAC driver 120 to interface with SME functions 114 provided by the OEM vendor. An RRM porting and OS abstraction API 124 is also implemented in the MAC driver 120. The RRM porting and OA abstraction API 124 preferably includes memory allocation APIs, buffer management APIs and timer services APIs. These APIs are portable operating system interface (POSIX), which is an open operating interface standard produced by IEEE and recognized by ISO and ANSI, standard compliant to allow platform independence and easy portability. An RRM API 132 for OAM is implemented in the OAM agent 130 for both proprietary and standard management information block (MIB) access 134, 136.

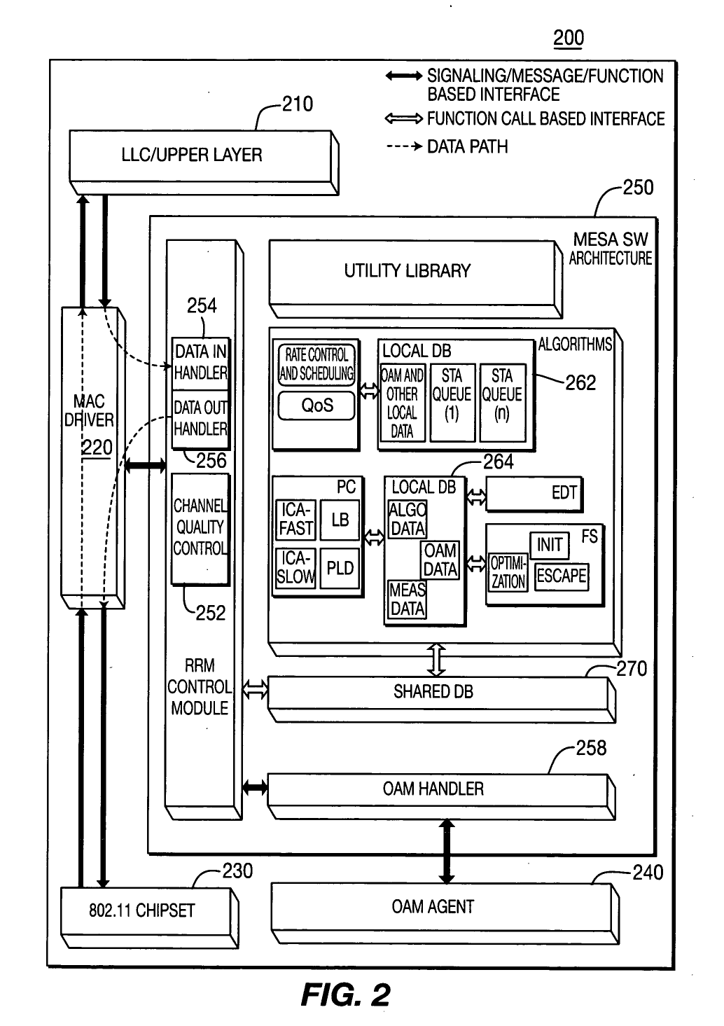

FIG. 2 is a block diagram of a system 200 incorporating a MESA software architecture in accordance with the present invention. The system 200 comprises a higher layer entity 210, a MAC driver 220, an 802.11 chipset 230, an OAM agent 240, and a MESA software architecture 250. The MESA software architecture 250 comprises a plurality of tasks including a channelQualCtrl task 252, a Data_In task 254, a Data_Out task 256, and an OAM_Handler task 258.

The ChannelQualCtrl task 252 collects measurements from the MAC driver 220, such as received packet error rate (Rx PER). Different measurements may have different periodicity. The ChannelQualCtrl task 252 coordinates with other tasks for measurement collection and performs relevant filtering as required. The ChannelQualCtrl task 252 also handles association request messages from the MAC driver 220 and collects acknowledge (ACK) messages meant for neighboring APs during a silent measurement period (SMP). An SMP is period during which the AP does not transmit any data but just listens to its environments in order to collect measurements used by MESA algorithms. The ChannelQualCtrl task 252 implements algorithms such as frequency selection algorithms, energy detect threshold algorithms, and power control algorithms. Loud packets generation logic is implemented in the Data_Out task 256.

The algorithms implemented in the ChannelQualCtrl task 252 may be invoked based on periodic timers or predefined measurement threshold triggers. The ChannelQualCtrl task 252 shares the control of the startup phase with the OAM_Handler task 258 and handles OAM requests such as enabling/disabling of RRM features. The QOS algorithms are distributed between the ChannelQualCtrl task 252 and the Data_Out task 256.

The Data_Out task 256 transfers data to the MAC driver 220 and collects statistics related to the transmitted data, such as bad frames count, good frames count, own AP channel utilization, the number of missing ACKs, etc. The Data_Out task 256 implements the rate control and scheduler algorithms and some part of QoS algorithms. In support of power control algorithms, the Data_Out task 256 estimates perceived received signal strength indicator (RSSI) by associated STAs using RSSI measurements collected by the Data_Out task 256 and updates histograms used by a power control slow interference estimation procedure. The Data_Out task 256 also updates the latest instance of own its AP load histogram by summing the duration of Tx packets into the relevant path loss bin maintained by the ChannelQualCtrl task 252.

The Data_In task 254 receives information required by MESA algorithms on incoming data from the MAC driver 220 and passes this information to an RRM software. The RRM software maintains a queue for each STA associated with the AP.

The OAM_Handler task 258 interacts with the OAM agent 240 to get and distribute configuration parameters to other MESA tasks, process various performances and fault management statistics collected by other MESA tasks, and filter these statistics as required for reporting purposes to an OAM manager (not shown) via the OAM agent 240. The OAM_Handler task 258 also reports MESA software ready status, (as received from the ChannelQualCtrl task 252), to the OAM agent 240.

The MESA software architecture in accordance with the present invention uses a distributed database approach to minimize lock/unlock requirements and related negative impact on the system performance. The databases are categorized into two categories: a local database, such as databases 262, 264 and a shared database 270.

There is at least one local database per task. The local databases include the following sub-databases: configuration parameters specific to each task; measurement data; and algorithm specific internal data. Configuration parameters come from a MIB and are distributed by the OAM_Handler task 258 which gets them from the OAM agent 240. Algorithm specific internal data needs to be kept in a database specific to that algorithm. This includes outputs from filtering performed on a measurement database. The local database for the OAM_Handler task 258 may include performance and statistics data being gathered to report to the OAM manager.

The shared database 270 includes data that may need to be shared by more than one task. The shared database 270 also includes configuration parameters that need to be shared among several tasks, measurement data that needs to be used by more than one task, and algorithm outputs that need to be seen by other tasks.

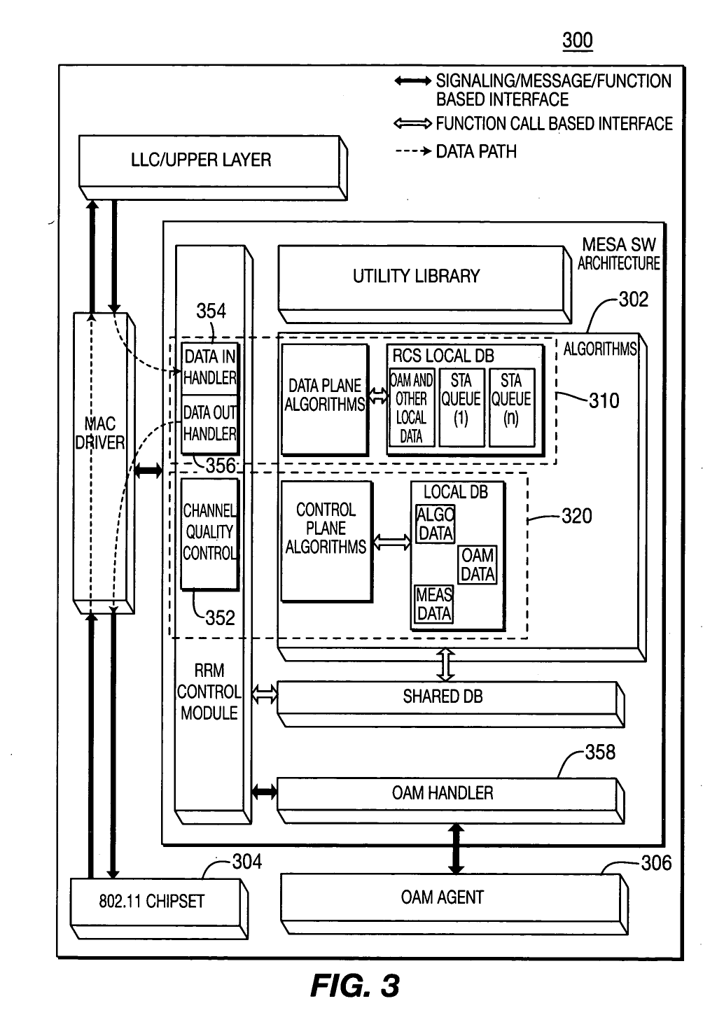

FIG. 3 is a diagram of a system 300 wherein a MESA software architecture 302 includes a data plane 310 and a control plane 320 in accordance with the present invention. In accordance with the present invention, a control plane 310 is separated from a data plane 320 providing flexibility in the prioritization of data handling, (i.e. data outflow versus data inflow). The modular architecture of the present invention provides easy future scalability and enables feature activation separately from each other. Portability can be achieved by a well defined interface to external modules, such as a 802.11 chipset driver 304, OAM Agent 306 and OS (not shown). All tasks can run concurrently, which enables measurements to be processed in the background while data are being transferred at the same time. Data plane algorithms determine the optimum data rate, schedule transmission queues, and implement part of admission control and congestion control, (i.e., QoS), algorithms. Control plane algorithms implement frequency management, power control and part of QoS related algorithms.

By way of example, below is an explanation of tasks performed during a startup phase. In the startup phase, the ChannelQualCtrl task 352 operates in an initialization state (Init state) and a Discovery_SMP state. In Init state, the ChannelQualCtrl task 352 gets initial OAM configuration parameters and performs a software initialization procedure(s). In the Discovery_SMP state, the SMP activities are performed. At the end of the Discovery_SMP state, the ChannelQualCtrl task 352 signals to the Data_Out task 356 and remains in the same state. Once the ChannelQualCtrl task 352 receives an indication from the Data_Out task 356 indicating the end of the loud packet generation procedure, the ChannelQualCtrl task 352 performs the initial Tx power computation. The ChannelQualCtrl task 352 then indicates to other tasks, (i.e., Data_Out 356, Data_In 354, and OAM_Handler 358 tasks), the end of the startup phase, sets all the timers for normal operation phase, sets relevant measurements and transits to a NormalOp_Main state.

In startup phase, the Data_Out task 356 operates in Init state and Discovery_LPG state. In Init state, the Data_Out task 356 gets initial OAM configuration parameters and performs software initialization procedures. In Discovery_LPG state, the Data_Out task 356 executes startup phase loud packets generation procedure. At the end of the procedure, the Data_Out task 356 signals the ChannelQualCtrl task 352 to indicate the end of the loud packet generation procedure and remain in the same state.

In start up phase, the Data_In task 354 gets OAM initial OAM configuration parameters and performs software initialization procedures. The Data_In task 354 transitions from the Init state to a NormalOp_Main state at the reception of the message indicating the end of startup phase from the ChannelQualCtrl task 352.

In startup phase, the OAM_Handler task 358 operates in the Init state. In this state, the OAM_Handler task 358 gets OAM initial OAM configuration parameters and performs software initialization procedures. The OAM_Handler task 358 also distributes OAM parameters to other MESA tasks.

After the startup phase, the MESA software enters a normal operation phase. The possible states of the ChannelQualCtrl task 352 in normal operation phase are a NormalOp_Main state, a NormalOp_SMP state, and a ChannelUpdate state.

In the NormalOp_Main state, the ChannelQualCtrl task 352 gathers measurements and various statistics on data received from associated STAs, filters the measurements, estimates periodically current channel utilization of the AP and executes MESA algorithms. In the NormalOp_SMP state, the ChannelQualCtrl task 352 collects measurements on neighboring APs such as channel utilization, RSSI in the presence of carrier lock for all channel in ACS including channels being currently used by the AP, RSSI in the absence of carrier lock (interference measurement), the number of ACKs sent by STAs to neighboring APs. Filtering of measurements is always running in the background regardless of the state. The Data_Out task 356 or the Data_In task 354 does not need to be aware of the NormalOP_SMP state of the ChannelQualCtrl task 352. The timer used to guard ACK/NACK reception by the Data_Out task 356 for transmitted data to associated STAs shall be set to a value larger than normal operation phase SMP duration. During channel update, the ChannelQualCtrl task 352 transitions to the ChannelUpdate state.

The states of the Data_Out task 356 in a normal operation phase are a NormalOp_Main state and a WaitForAck state. In the NormalOp_Main state, the Data_Out task 356 transfers data to the MAC driver, updates slow interference evaluation statistics, (i.e. prediction of perceived RSSI by STAs), and other statistics that belong to the Data_Out task 356 activity's definitions. The measurements of RSSI perceived by the AP are collected by the ChannelQualCtrl task 352 and stored in measurement database. Tx Power level change indication is also transferred by the Data_Out task 356 to the MAC driver upon notification from the ChannelQualCtrl task 352.

In the WaitForAck state, the Data_Out task 356 waits for ACK/NACK. Assuming that ACK and NACK are tracked by the MAC and that the NACK timer resides in the MAC, there is no need to explicitly track the timer that guards loud packet transmission duration (say, T), with a separate timer. However, with this scenario, an internal variable is preferably provided to track whether the timer (T) should be reset or not upon reception of ACK/NACK.

In normal operation phase, the Data_In task 354 operates in the NormalOp_Main state. In this state, the Data_In task 354 performs normal data transfer activities between the Data_In task 354 and the Data_Out task 356.

In normal operation phase, the OAM_Handler task 358 operates in the NormalOp_Main state. In this state, the OAM_Handler task 358 routes audit and parameters update requests to other MESA software tasks, processes performance and fault management requests from the OAM agents and performs filtering as required.

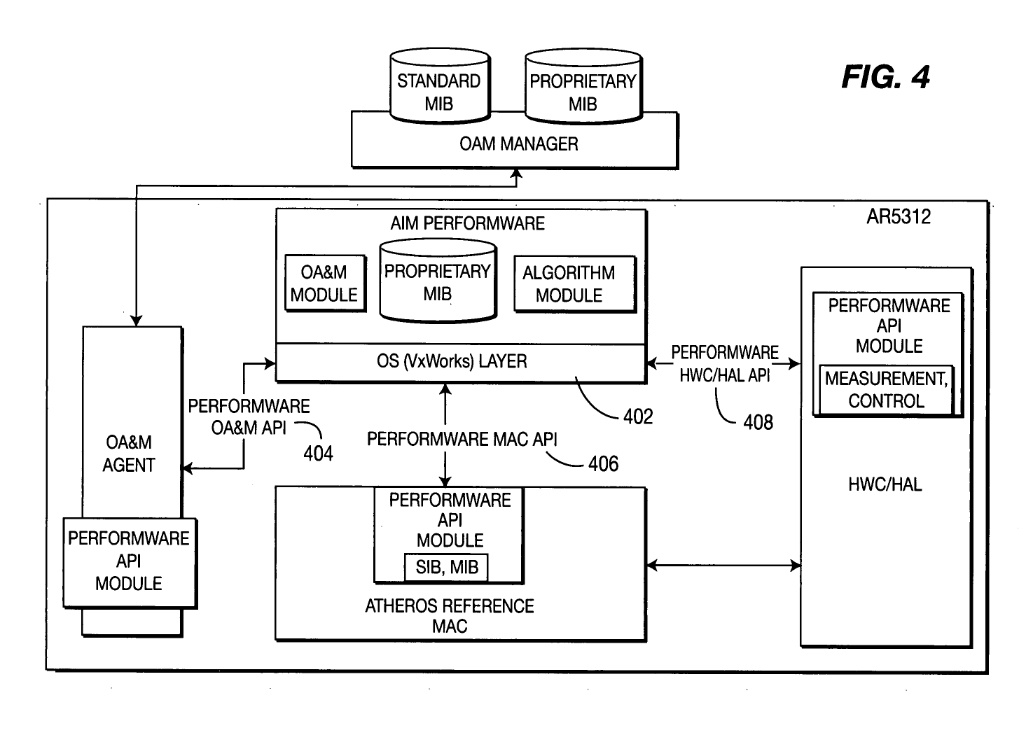

FIG. 4 is an example of integration of MESA software architecture on a commercial AP in accordance with the present invention. MESA software product that is branded “Performware” by InterDigital Communications Corporation is integrated to an Atheros AP platform. In this example, the APIs are divided in three (3) categories: OS APIs (OS layer) 402; OAM APIs 404; and MAC/hardware control (HWC)/hardware abstraction layer (HAL) APIs. 406, 408

The OS APIs 402 provide generic functions which are used by MESA software to access OS services. These functions implement the details of each operating system such that the MESA software algorithms are unaware of the differences between the supporting underlying OSs.

Each target platform may have different OAM agents with different implementations and network management protocol interfaces. The OAM APIs 404 isolate the MESA software from these differences by handling the specificity of each OAM agent implementation.

The MAC/HWC/HAL APIs 406, 408 provide to MESA software a uniform access, regardless of the AP platform differences, to MAC and physical layer resources for the purpose of controlling the AP operation parameters, (i.e., frequency, power level, etc.), associated stations as well as measurements required the MESA algorithms.

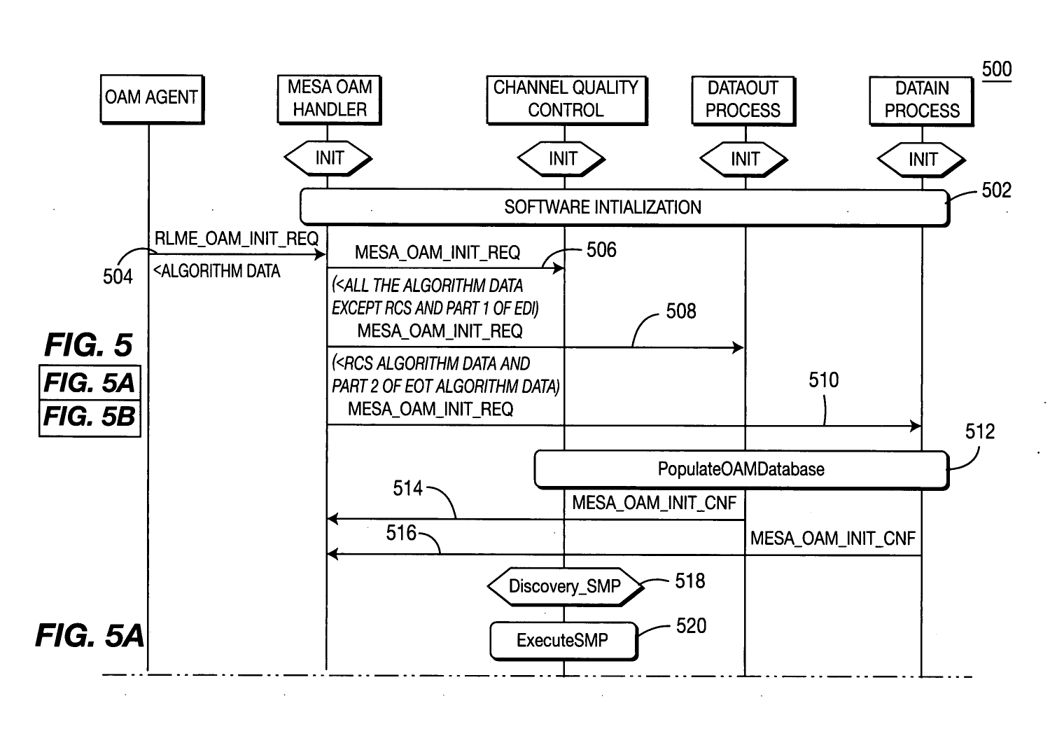

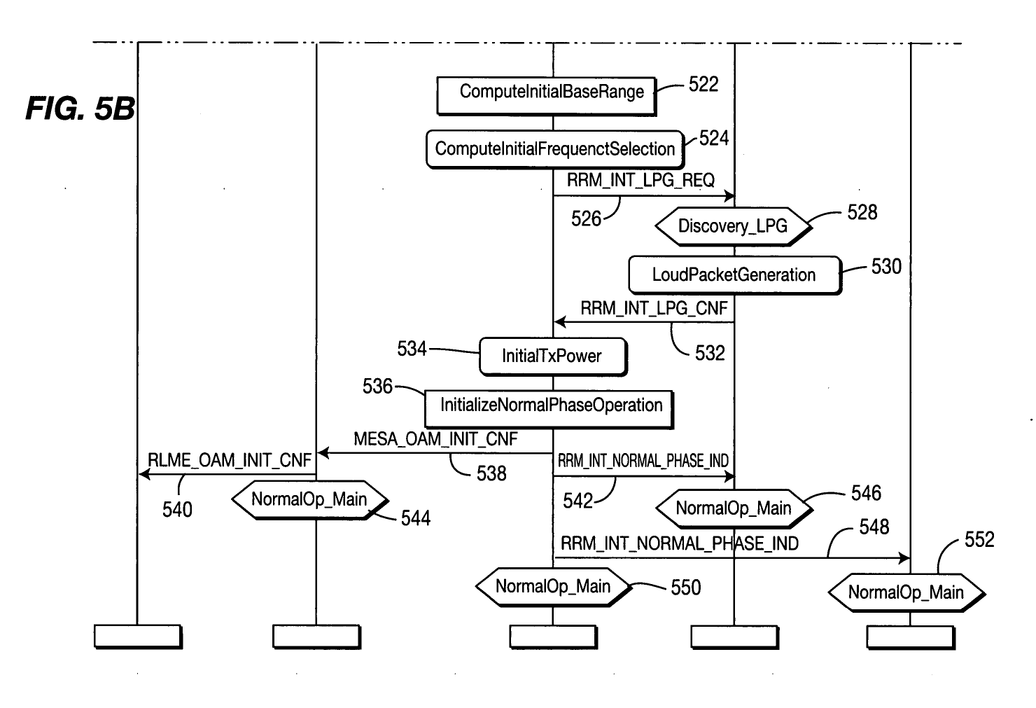

Referring to FIG. 5, the activities performed during the MESA software startup procedure is explained in sequence. After power up of the AP, the OEM vendor software invokes the MESA software's main startup function. In the startup function, following OS services pertaining to MESA software are initialized: memory and buffer management services; communication channels (between MESA tasks and environment and between different tasks); timer services; and synchronization services. The identifiers of the channels are stored in a global structure to facilitate communication between different tasks. After initializing the above-mentioned services, the startup function spawns different application tasks.

In the Init state, all the tasks perform software initialization (step 502). The OAM agent sends an OAM initiation request to the OAM_Handler task (step 504). The OAM_Handler task forwards the request to the ChannelQualCtrl task (step 506). All the algorithm data are forwarded to the Data_Out task except rate control and scheduler (RCS) and part 1 of energy detect threshold (EDT), which are forwarded to the Data_In task (steps 508, 510). The ChannelQualCtrl task, Data_Out task and Data_In task populate the OAM database (step 512). The Data_Out task and Data_In task sends OAM initiation confirmation to the OAM_Handler task (steps 514, 516). The ChannelQualCtrl task enters a Discovery_SMP state (step 518), and performs SMP activities (step 520). The ChannelQualCtrl task computes initial base range at step 522 and executes initial frequency selection (step 524). The ChannelQualCtrl task then sends a loud packet generation (LPG) request to the Data_Out task at step 526. The LPG request is discovered in step 528 and the Data_Out task generates loud packets at step 530 and confirms it to the ChannelQualCtrl task (step 532). Upon receipt of the confirmation, the ChannelQualCtrl task computes initial Tx power and initialize normal operation (steps 534, 536). The ChannelQualCtrl task sends an indication for start of normal operation to the Data_Out task and the Data_In task (steps 542, 548, respectively), and sends an OAM initiation confirmation to the OAM_Handler task (step 538), which forwards the confirmation to the OAM agent (step 540). Then, the Data_In task, Data_Out task, ChannelQualCtrl task, and OAM_Handler task enters normal operation (steps 552, 546, 550, and 544, respectively).

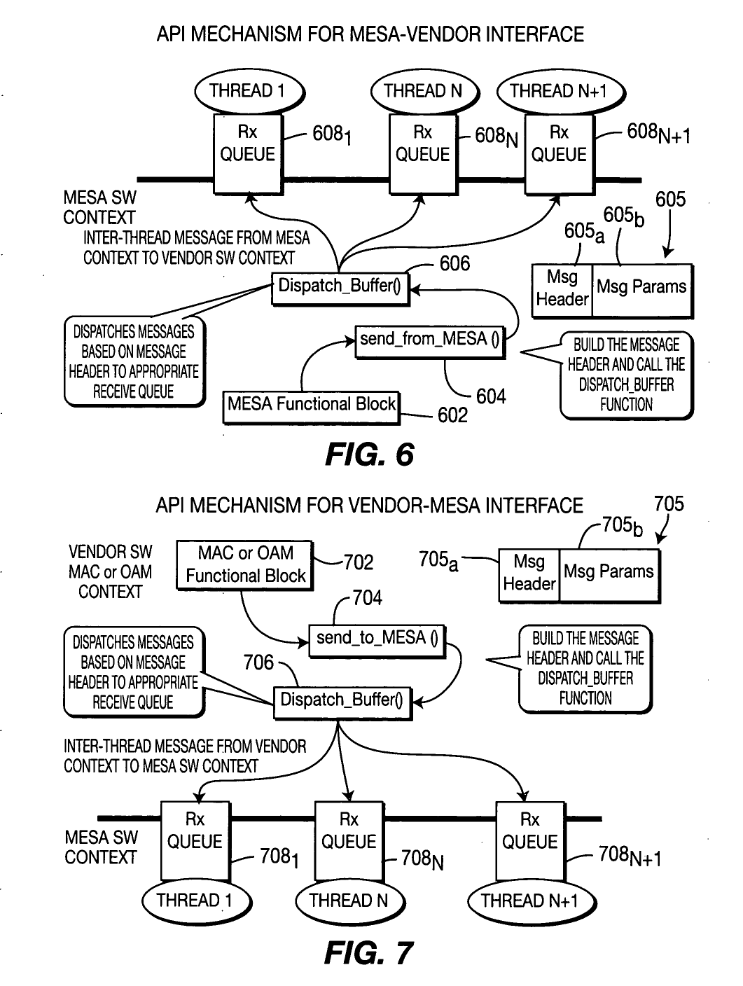

An API mechanism in accordance with the present invention is explained with reference to FIGS. 6 and 7. In accordance with the present invention, a single interface to/from OEM vendor software, (i.e., send_to_mesa and send_from_mesa functions), and a Dispatch_Buffer function which is called internally by send_to_mesa or send_from_mesa functions are provided to transfer the message to the appropriate receiver task. It is noted that while a single interface is provided, the interface implementation can be changed as needed.

FIG. 6 shows an API mechanism for communication from an external environment to MESA software. A MESA functional block 602 calls a send_from_MESA function 604 to transfer a message to a receiver task 608₁, 608_{N}, 608_{N+1}. The send_from_MESA function 604 generates a message 605 comprising a message header 605a and message parameters 605b, and calls the Dispatch_Buffer function 606. The call may be a functional call or a message to a router's system message queue. The Dispatch_Buffer function 606 places the message 605 in the receiver task message queue based on the message header 605a. The tasks continuously monitor their queue for a new message and then call its internal API processing function when one is detected.

FIG. 7 shows an API mechanism for communication from MESA software to an external environment. A MAC or OAM functional block 702 calls a send_to_MESA function 704 to transfer a message to a receiver task 708₁, 708_{N}, and 708_{N+1}. The send_to_MESA function 704 generates a message 705 comprising a message header 705a and message parameters 705b, and calls the Dispatch_Buffer function 706. The Dispatch_Buffer function 706 places the message 705 in the receiver task message queue based on the message header 705a.

This scheme provides a clean separation between MESA software and vendor software, and uses POSIX message queues, one per receiver task. The receiver task queues preferably belong to a shared memory domain that is controlled by an OS kernel. This scheme requires two system calls, one to place the message into the receiver queue and the other to retrieve the message from the receiver queue. The system call, (especially at the receiver side), may cause a receiver task to be rescheduled. The buffer being dispatched may not be big, (e.g., a few bytes). In a data plane, as described in connection with FIG. 3, the actual user data is referenced and not copied.

Some of the MESA features may be directly implemented into the vendor software context if required by the vendor. In this case, the Dispatch_Buffer function 706 may directly call the receiver function that processes the specific API. However, this requires detailed knowledge of vendor's software architecture with additional front end customization effort. The advantage of this approach is that it provides performance improvement especially for algorithms implemented in the data path. Data plane algorithms may benefit from this.

Although the elements in the Figures are illustrated as separate elements, these elements may be implemented on a single integrated circuit (IC), such as an application specific integrated circuit (ASIC), multiple ICs, discrete components, or a combination of discrete components and IC(s). Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

1. A system for supporting portable and modular software implementation in different platforms in a wireless local area network (WLAN) node, the node including a higher layer entity, a medium access control (MAC) driver, an operation, administration and maintenance (OAM) agent and a physical layer entity, the system comprising:
a control plane configured to implement a control plane algorithm while interacting with the MAC driver;
a data plane configured to implement a data plane algorithm while interacting with the MAC driver;
an OAM handler task configured to interact with the OAM agent; and
an application programming interface (API) enabling interaction with external modules regardless of specificity and implementations of the external modules.

2. The system of claim 1 wherein the control plane includes a channel quality control task and the data plane includes a data-in task and a data-out task, the channel quality control task collecting measurements from the MAC driver and coordinating with other tasks, the data-in task and the data-out task transferring data from and to the MAC driver.

3. The system of claim 2 wherein the channel quality control task handles association request messages from the MAC driver and collects acknowledge (ACK) messages for neighboring APs during a silent measurement period.

4. The system of claim 2 wherein the channel quality control task implements frequency selection algorithms, energy detect threshold algorithms and power control algorithms.

5. The system of claim 4 wherein the channel quality control task implements the algorithms periodically.

6. The system of claim 4 wherein the channel quality control task implements the algorithms in accordance with predefined threshold triggers.

7. The system of claim 1 wherein a radio resource management (RRM) API is implemented in the MAC driver for collecting measurements and statistics and updating a MAC and physical layer entity with the RRM output.

8. The system of claim 1 wherein at least one OEM function which is provided by OEM vendors is included in the node, and OEM vendor's API is implemented in the MAC driver.

9. The system of claim 8 wherein a MESA functional block is provided to transfer a message between the OEM function and an appropriate MESA task.

10. The system of claim 9 wherein a dispatch function is called by the MESA functional block to transfer the message to the appropriate task in accordance with a message header.

11. The system of claim 10 wherein the dispatch function is called by either a functional call or a message to a router's system message queue.

12. The system of claim 9 wherein a queue of the MESA task belongs to a share memory domain that is controlled by an operating system (OS) kernel.

13. The system of claim 10 wherein at least one MESA task is implemented in the OEM function.

14. The system of claim 13 wherein the dispatch function directly calls an appropriate function that processes the API.

15. The system of claim 1 wherein an RRM porting and operating system (OS) abstraction API is implemented in the MAC driver.

16. The system of claim 15 wherein the RRM porting and OS abstraction API includes memory allocation APIs, buffer management APIs and timer services APIs.

17. The system of claim 1 wherein an RRM API for OAM is implemented in the OAM agent for both proprietary and standard management information base (MIB) access.

18. The system of claim 1 wherein the node is one of an access point (AP), a WLAN router, and a terminal station.

19. The system of claim 2 wherein each task is provided with a local database and a shared database is provided for storing data to be accessed by all the tasks.

20. The system of claim 19 wherein the local data base includes configuration parameters specific to each task, measurement data, and algorithm specific internal data.

21. The system of claim 19 wherein the shared database includes configuration parameters, measurement data, and algorithm outputs that need to be shared among several tasks.

22. The system of claim 2 wherein all the tasks run concurrently.
